(19) United States
(12) Patent Application Publication
(10) Pub. No.: US 2002/0046353 A1
(43) Pub. Date: Apr. 18, 2002

(54) User authentication method and user authentication server

(75) Inventor: Toyoaki Kishimoto, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: SONY CORPORATION, Tokyo (JP)

(21) Appl. No.: 09/929,121

(22) Filed: Aug. 15, 2001

(30) Foreign Application Priority Data
Aug. 18, 2000 (JP) 2000-248799

(51) Int. Cl. H04L 9/32; H04M 1/66

(52) U.S. Cl. 713/202; 380/247; 455/410

(57) ABSTRACT

A user authentication method suitably for use in mobile information terminals, which minimizes user load in entering information necessary for user authentication while ensuring security is disclosed. Before using a service to be provided by a client service provider on the Internet, the user registers his user personal information including the unique identification information of a mobile information terminal with the client service provider. Then, when the user of the mobile information terminal uses a content server via the client service provider by use of the mobile information terminal, the mobile information terminal sends the encrypted unique identification information. The client service provider decrypts the received encrypted unique identification information and performs user authentication on the basis of the decrypted unique identification information. The client service provider also checks a charging surrogate service server for the registration of the user. If the user is authenticated and found registered, the client service provider permits the content server to provide a service requested by the user of the mobile information terminal.

### BACKGROUND OF THE INVENTION

The present invention relates generally to a user authentication and charging for a service in an information providing system especially suitable for mobile information terminals.

Recently, mobile phones having the Internet connection capability has been rapidly gaining in popularity, which in turn rapidly increasing Internet sites for providing various kinds of services such as information provision. Some pieces of the provided information are free of charge, while the others are chargeable, and the latter case happens more often than the former case. The chargeable information provision requires user authentication every time each user receives a particular service and, at the same time, a predetermined charging system is required.

In the currently popular information providing services for mobile phones, each mobile phone company operates both as carrier (a communication common carrier) and Internet service provider to enable a comparatively simple user authentication procedure based on the use of the subscriber number and password of each mobile phone. For a charging method, so-called carrier charging is employed in which the service usage fee is collected along with the telephone usage fee. These user authentication and charging methods are dependent on Internet connection providers, which is realized on the premise that each Internet connection provider be a carrier.

The mobile phone is originally intended for voice talk. Therefore, the resolution and color bits of its display screen, the storage capacity, and the processing performance do not reach those of a mobile information terminal, which is called a PDA (Personal Digital Assistant). The mobile information terminal is also capable of accessing the Internet via its communication device such as a mobile phone, thereby providing usefulness higher than the mobile phone through various kinds of capabilities such as personal information management, schedule management, memo management, and electronic mail transfer and a relatively large-sized display screen without scarifying the PDA's mobility.

When performing the information providing services on the Internet for mobile information terminals such as mentioned above, it is inappropriate to use the subscriber number for user authentication because the user of each mobile information terminal does not always use a same communication device (for example, a mobile phone) to access the Internet.

Instead of the subscriber number, a user ID may be used for user authentication. However, it would take much time and labor for each user to enter his user ID every time he uses a service from an information providing site (IP site) for example. Especially, with mobile information terminals based on a hand-drawn character recognition technique in which characters must be normally inputted with a stylus (or so-called pen) rather than a keyboard or on a software keyboard in which characters are inputted by pen touch operation, it would take much time and labor for the user to input his user ID and other characters. If this inconvenience makes users of mobile information terminals hesitate to use the services provided by information providing sites, it would be a loss to these sites. In addition, if these mobile information terminals are not dependent on Internet connection providers, or carriers, each user ID must be transferred over the Internet, which is an open network incapable of assuring the confidentiality of transferred data, thereby posing a risk in security.

### SUMMARY OF THE INVENTION

It is therefore an object of the present invention to provide a user authentication method for the information provision services suitable for mobile information terminals which minimizes the time and labor of each user in executing user authentication while considering its security.

In carrying out the invention and according to one aspect thereof, there is provided a user authentication method for an authentication server which executes user authentication between a mobile information terminal and a content providing server interconnected by an open network not guaranteeing the security of data to be transferred, comprising the steps of: registering unique identification information stored in the mobile information terminal with a customer database of the authentication server in advance; decoding the unique identification information encrypted by a predetermined encryption algorithm and supplied from the mobile information terminal via the open network; determining whether the unique identification information decoded in the decoding step is registered with the customer database; and sending a notification to the content providing server that starting of service provision for the mobile information terminal be permitted, if the unique identification information is found registered with the customer database in the determining step.

In carrying out the invention and according to another aspect thereof, there is provided a user authentication server which executes user authentication between a mobile information terminal and a content providing server interconnected by an open network not guaranteeing the security of data to be transferred, comprising: registering means for registering unique identification information stored in the mobile information terminal with a customer database of the authentication server in advance; decoding means for decoding the unique identification information encrypted by a predetermined encryption algorithm and supplied from the mobile information terminal via the open network; determining means for determining whether the unique identification information decoded by the decoding means is registered with the customer database; and service permission notice sending means for sending a notification to the content providing server that starting of service provision for the mobile information terminal be permitted, if the unique identification information is found registered with the customer database by the determining means.

### BRIEF DESCRIPTION OF THE DRAWINGS

These and other objects of the invention will be seen by reference to the description, taken in connection with the accompanying drawing, in which:

FIG. 1 is schematic diagram illustrating an exemplary configuration of an information providing service system in its entirety practiced as a first embodiment of the invention;

FIG. 2 is a top view illustrating an external view of a mobile information terminal (PDA) shown in FIG. 1;

FIG. 3 is a block diagram illustrating an exemplary general hardware configuration of the PDA shown in FIG. 1;

FIG. 4 is a block diagram illustrating an overview of a general hardware configuration of a server for use in the present embodiment;

FIG. 5 is a schematic diagram illustrating an online user registration process in the present embodiment;

FIG. 6 illustrates an exemplary structure of a customer database of a client service provider in the present embodiment;

FIG. 7 is a schematic diagram illustrating a general procedure for transferring information between a mobile phone (a client) and each of the servers at the time of Web channel registration (so-called subscription or My Menu registration) in the present embodiment;

FIG. 8 is a schematic diagram illustrating a procedure in which the user accesses a Web site from the user's mobile phone after the Web channel registration performed in FIG. 7;

FIG. 9 illustrates an exemplary initial menu screen on the PDA supplied from a Web server of the client service provider in the present embodiment;

FIG. 10 illustrates another exemplary screen on the PDA in the present embodiment;

FIG. 11 illustrates further another exemplary screen on the PDA in the present embodiment;

FIG. 12 illustrates still another exemplary screen on the PDA in the present embodiment;

FIG. 13 illustrates still another exemplary screen on the PDA in the present embodiment;

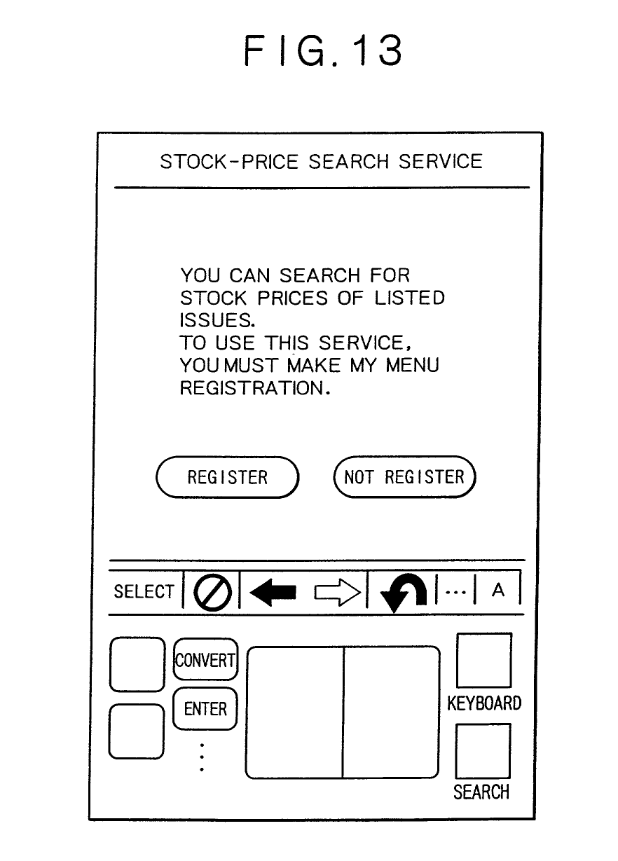

FIG. 14 is still another exemplary screen on the PDA in the present embodiment;

FIG. 15 is still another exemplary screen on the PDA in the present embodiment;

FIG. 16 is a flowchart describing time-series operations to be performed by the client and each server at the time of My Menu registration in the present embodiment;

FIG. 17 is a flowchart describing time-series operations to be performed by the client and each server at the time of service usage in the present embodiment;

FIG. 18 is a flowchart describing time-series operations to be performed by the client and each server at the time of cancellation in the present embodiment;

FIG. 19 is a flowchart describing the flows of the processing operations for the client service provider authentication to be performed in a terminal browser between the same and client service provider and for the transmitting of encrypted data from the browser to the client service provider;

FIG. 20 is a schematic diagram illustrating an overall configuration of a network system practiced as a second embodiment of the invention;

FIG. 21 is a perspective view illustrating an external configuration of a camera-equipped digital mobile phone shown in FIG. 20;

FIG. 22 is a partial perspective view illustrating a display section of the camera-equipped digital mobile phone shown in FIG. 21 with its camera section rotated; and

FIG. 23 is a block diagram illustrating a circuit configuration of the camera-equipped digital mobile phone shown in FIG. 21.

### DETAILED DESCRIPTION OF PREFERRED EMBODIMENTS

This invention will be described in further detail by way of example with reference to the accompanying drawings.

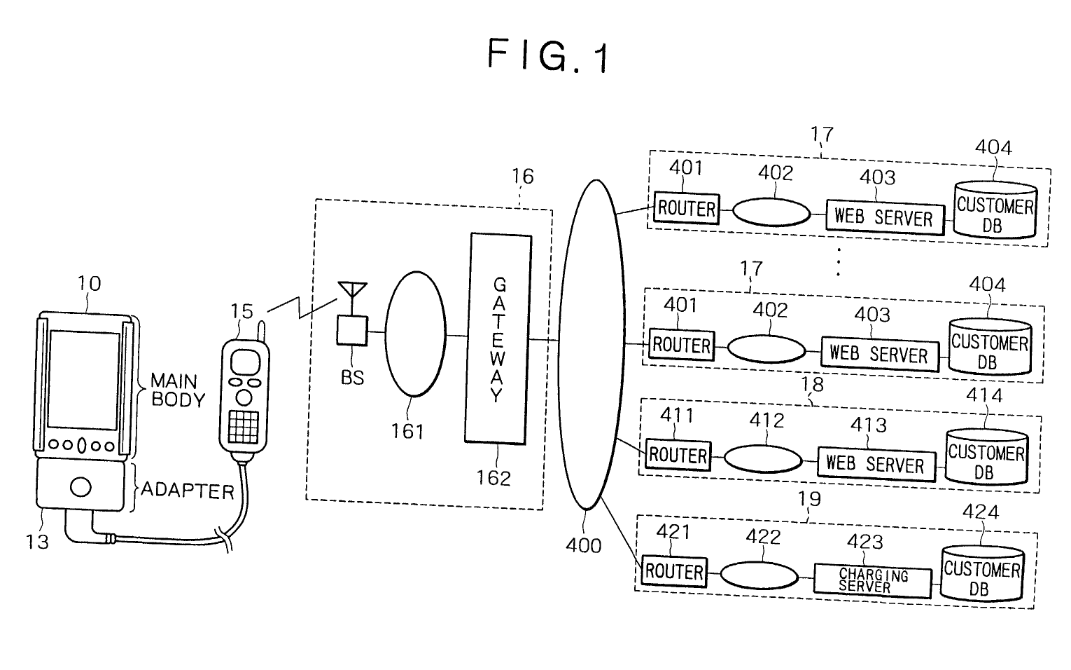

Now referring to FIG. 1, there is shown an exemplary configuration of an information providing system practiced as a first embodiment of the invention. Term “system” here used denotes a logically assembly of a plurality of units, which need not necessarily be integrated in a same housing.

When connecting to the Internet, a mobile information terminal (or PDA (Personal Digital Assistant)) 10 is connected to a mobile phone 15 (including a so-called PHS (Personal Handyphone System), which is an existing communication device, via an adapter 13. The mobile phone 15 is connected to a mobile network 161 via a predetermined base station BS and further to the Internet 400 via a gateway 162. In this example, an Internet connection provider 16 of a carrier is used; however, Internet connection providers of other than carriers may also be used.

A Web server 403 forming a plurality of mobile content providers 17 (hereafter referred simply to content servers) for performing various information providing services mainly for mobile information terminals, a Web server 413 forming a client service provider 18 which functions as a so-called portal site for the mobile information terminal in the present embodiment, and a charging server 423 forming a charging surrogate service provider 19 for surrogating the charging to the mobile information terminal user for the mobile content provider 17 are interconnected by the Internet 400.

The mobile content provider 17 is mainly composed of a router 401, a LAN 402, the Web server 403, and a customer database 404 (hereafter a database will also be referred simply to a DB). The Web server 403 provides, to clients, documents written in a markup language such as HTML (Hyper Text Markup Language) by following HTTP (Hyper Text Transport Protocol). The customer DB 404 stores the flash ID, name, age, birthday, gender, home and office addresses, telephone and facsimile numbers, and the password (if necessary) for service concerned of each user registered for an information providing service concerned. The flash ID is unique identification information allocated to each mobile information terminal. The flash ID is so called because it is normally stored in a flash memory. Generally, the flash ID is represented by alphanumeric characters of about 12 bytes long and consists of a maker code for identifying the maker of the mobile information terminal and an identification code unique to each mobile information terminal of each maker.

The client service provider 18 is also mainly composed of a router 411, a LAN 412, the Web server 413 and a customer DB 414. The customer DB 414 stores various kinds of personal information about each user of the mobile information terminal 10. This personal information includes the flash ID, which is the unique identification information of the mobile information terminal concerned, name, age, birthday, gender, home and office addresses, telephone and facsimile numbers, the login ID and password for Internet connection, mail address, My Menu (side ID and monthly fee for example), and charging ID of each user. My Menu denotes a menu listing the site IDs selected and registered by the user from among the official sites stored in the client service provider 18, which is a portal site. The charging ID is a user identifier associated with the charging processing of the user concerned registered with the charging surrogate service provider 19. For example, the charging ID is Smash ID in Smash (trademark) service of provider So-net (trademark). It should be noted that the charging surrogate in the present invention is not limited to above-mentioned one; any other existing charging surrogate services may be available.

The charging surrogate service provider 19 is mainly composed of a router 421, a LAN 422, the charging server 423, and a customer DB 424. The charging server 423 performs charging surrogate processing with other servers and clients and includes a mail server capability. The customer DB 424 stores the name, age, birthday, gender, home and office addresses, telephone and facsimile numbers, credit card number (or account number for charging), and charging ID of each user registered for charging surrogate service.

In the example shown, the Internet connection provider 16, the client service provider 18, and the charging surrogate service provider 19 are arranged separately. Two or all of them may be provided by a single provider. The client service provider 18 and the charging surrogate service provider 19 may be separately interconnected with a leased line.

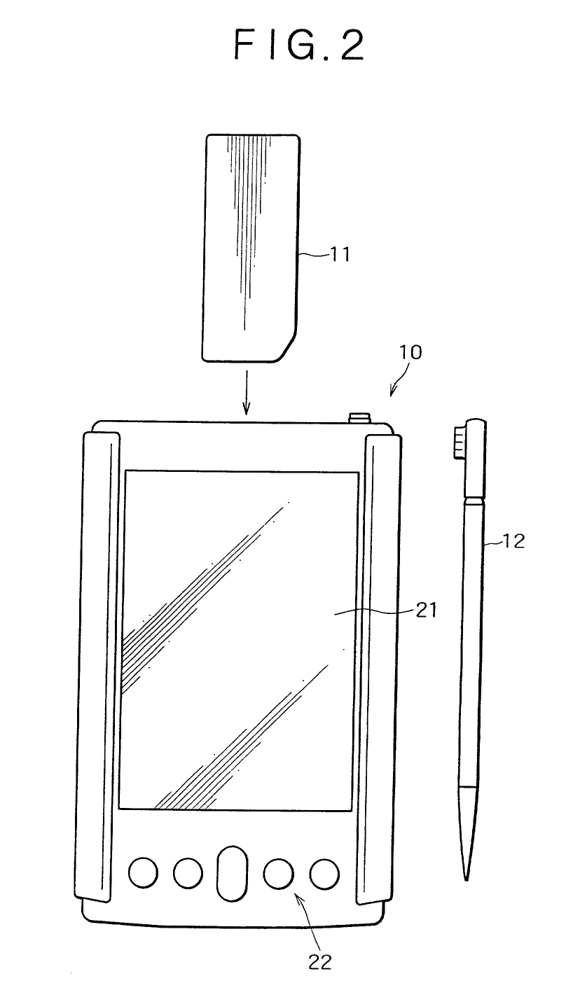

Referring to FIG. 2, there is shown an external configuration of the mobile information terminal (PDA) 10 in the present embodiment. The main body of the PDA 10 is generally rectangular in shape which allows its user to grasp it by the single hand, a display section 21 mostly occupying the front side. A touch pad (invisible) is arranged on the display section 21. Beneath the display section 21, hardware keys 22 are arranged. The main body is adapted to accommodate a stylus 12. With the stylus 12, the user can indicate positions on the touch pad or enter hand-written characters and graphics for example. A Memory Stick 11 (trademark of Sony Corporation) to be described later is detachably loaded in the top portion of the main body. Although not shown, a jog dial (to be described later) is partially projecting in a recess arranged in the top portion of the main body. The jog dial is arranged such that it can be operated with the thumb of the hand holding the PDA 10.

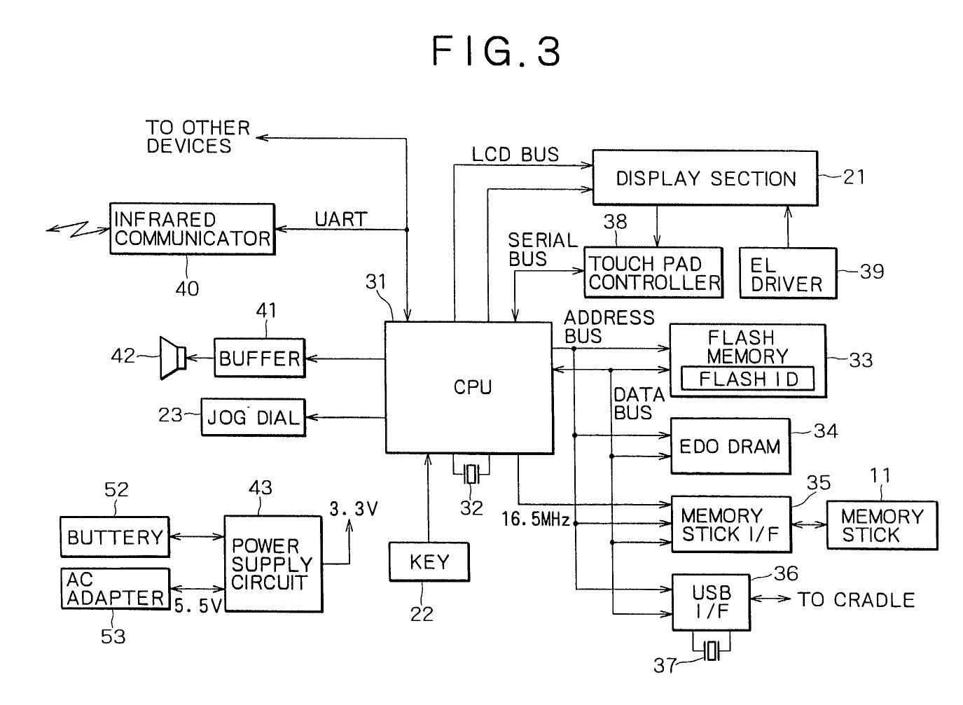

Referring to FIG. 3, there is shown a general hardware configuration of the PDA 10 in the present embodiment. A CPU (Central Processing Unit) 31, in synchronization with a clock signal supplied from an oscillator 32, executes such various programs stored in a flash ROM (Read Only Memory) 33 or an EDO DRAM (Extended Data Out Dynamic Random Access Memory) 34 as an operating system and application programs.

The flash ROM 33 is constituted by a flash memory, a kind of EEPROM (Electrically Erasable Programmable Read Only Memory), generally storing data which is basically fixed among the programs and parameters for use by the CPU 31. The flash ID used in the present embodiment is stored in the flash memory 33.

A Memory Stick interface (I/F) 35 reads data from the Memory Stick 11 loaded in the PDA 10 and writes data supplied from the CPU 31 to the Memory Stick 11 under the control of the CPU 31. A specific configuration of the Memory Stick 11 will be described later.

A USB (Universal Serial Bus) interface 36 inputs data or programs from a cradle (not shown), a connected USB device, in synchronization with a clock signal supplied from an oscillator 37 and supplies the data from the CPU 31 to the cradle under the control of the CPU 31. Although not shown, a drive for connecting a magnetic disk or an optical disk for example may be additionally connected to the USB interface 36.

The flash ROM 33, the EDO DRAM 34, the Memory Stick interface 35, and the USB interface 36 are connected to the CPU 31 via an address bus and a data bus.

The display section 21 is a liquid crystal display device in the present embodiment which receives data from the CPU 31 via an LCD bus to display the received data in image or text. A touch pad controller 38, when the touch pad arranged on the display section 21 is operated, receives data corresponding to the touch operation (indicative of the coordinates of a touch position for example) and supplies a signal corresponding to the received data to the CPU 31 via a serial bus.

An EL (Electro-luminescence) driver 39 operates an electro-luminescence element arranged on the backside of the display section 21 to control the brightness of the display section 21.

An Infrared communicator 40 transmits, by use of infrared light, data received from the CPU 31 to other devices, not shown, via a UART (Universal Asynchronous Receiver Transmitter) and transmits data supplied, by use of infrared light, from other devices to the CPU 31. The PDA 10 can communicate with other devices via the UART.

An audio reproducing section 42, composed of a speaker and an audio data decoder for example, decodes audio data for example received via the Internet 4, reproduces the received data, and sounds the reproduced data. For example, the audio reproducing section 42 reproduces the audio data supplied from the CPU 31 via a buffer 41 to sound the reproduced audio data.

The key section 22, composed of hardware input keys for example, is operated by the user when inputting various commands into the CPU 31. The job dial 23 is rotated or pressed by the user to supply corresponding data to the CPU 31.

A power supply circuit 43 converts the voltage of power supplied from a battery 52 or an AC (Alternating Current) adapter 53 and supplies the resultant voltage to the above-mentioned circuits, the CPU 31 through the audio reproducing section 42.

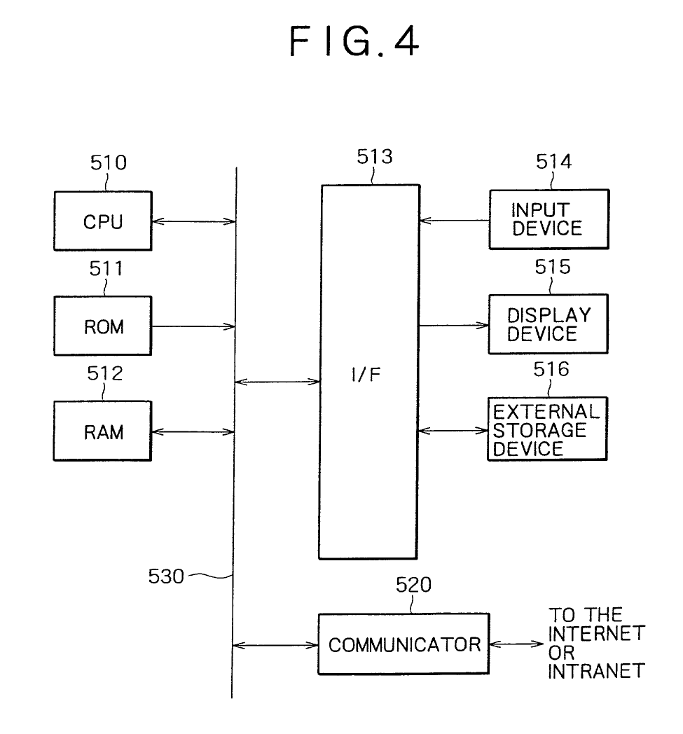

Referring to FIG. 4, there is shown a general hardware configuration of a server. A CPU 510 executes an OS (Operating System) and various application programs, controlling each component of the server. A ROM 511 stores fixed data among the programs to be executed by the CPU 510 and computational parameters. A RAM 512 provides a work area and a data temporary storage area for the CPU 510. The ROM 511 and the RAM 512 are connected to the CPU 510 via a bus 530. An input device 514 such as a keyboard, a display device 515 such as CRT or liquid crystal display, and an external storage device such as hard disk unit, MO, or CD-ROM are connected to the bus 530 via an interface 513. The bus 530 is connected to the Internet or an intranet (a LAN for example) via a communication section 520.

In what follows, an example will be described in which the user of the mobile information terminal 10 performs Web channel registration (or subscription) for continuous use of a service to be provided by a particular content provider selected from among a plurality of predetermined content providers (or official sites) by the user and predetermined charging (for example, XX yen a month) is performed on the purchased service. The Web channel registration will also be referred to as My Menu registration.

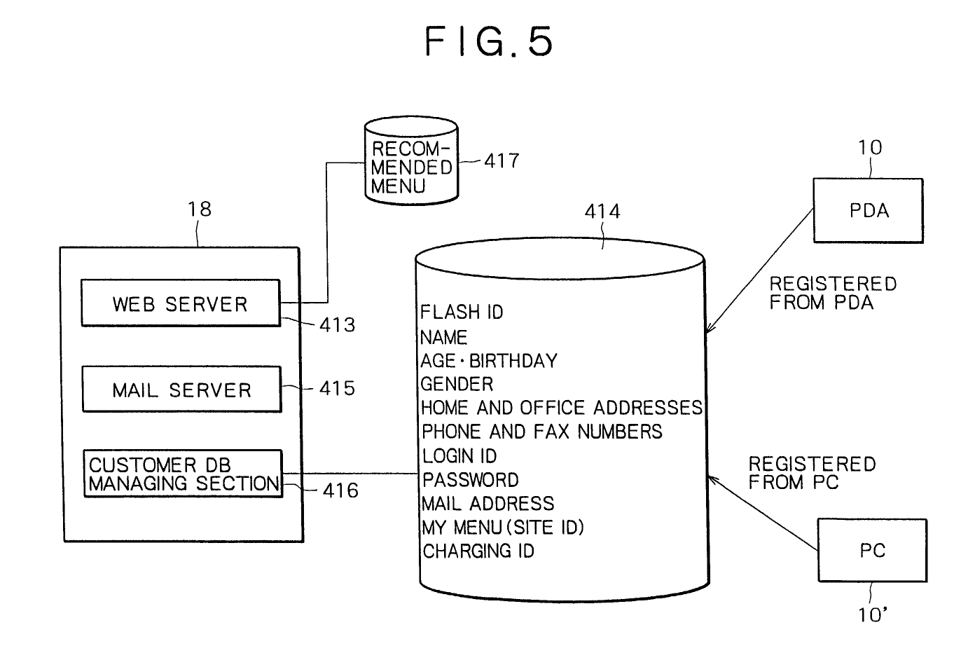

In operation, the PDA 10 first must make user registration with the client service provider 18. FIG. 5 shows an example of making this user registration online. In addition to the Web server 413, the client service provider 18 has a mail server 415, a customer database management section 416, and a recommended menu 417, which are not shown in FIG. 1. The recommended menu 417 includes site access information (or a site ID) for selectively accessing above-mentioned prepared official sites. The customer DB 414 is as described before.

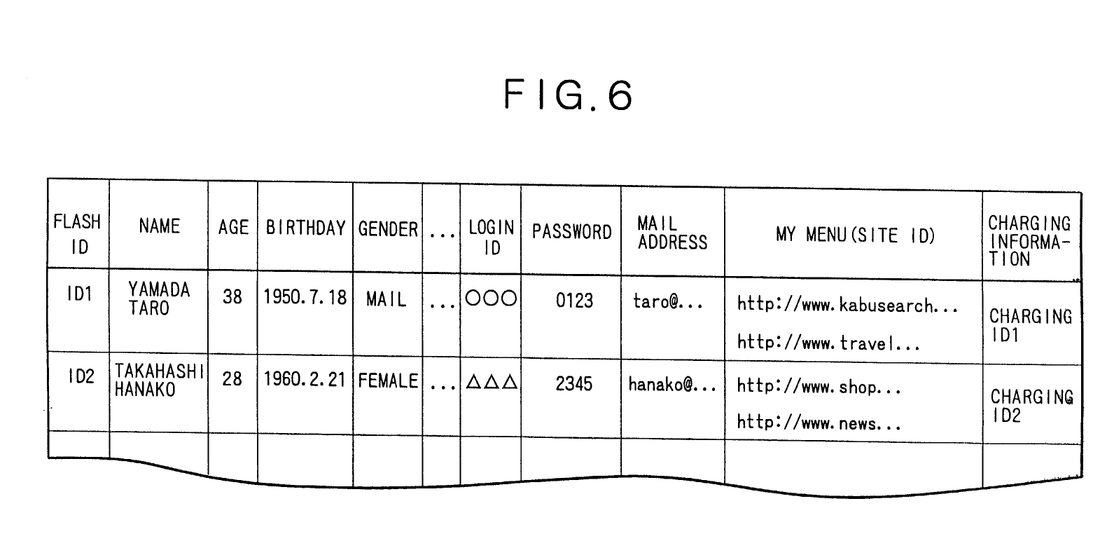

The user registration with the client service provider 18 is made from the mobile information terminal 10 or from a personal computer (PC) 10′. The user registration from the personal computer 10′ is permitted because this registration requires the user to input comparatively many characters, which is a comparatively cumbersome task to do on the mobile information terminal 10 as described before. The customer management database 414 includes records having the above-mentioned items for each flash ID as shown in FIG. 6. At the time of this user registration, the items of My Menu (site ID) have not yet been set. If the user registration for the charging service has not yet been performed at this stage, the items of charging information are not set. It is desirable for the information inputted at the time of the user registration to be encrypted in a method to be described later before transmission.

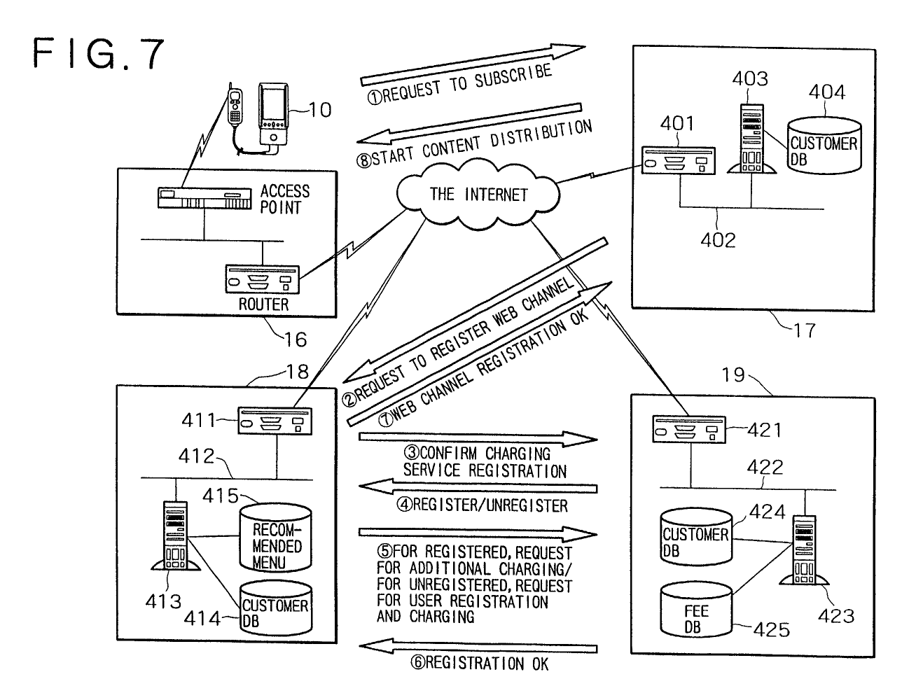

Referring to FIG. 7, there is shown a general procedure for transferring information between the PDA 10 (client) and each server at the time of the Web channel registration (or so-called subscription or My Menu registration) with a content provider to be performed after the above-described user registration with the client service provider 18. The user of the PDA 10 accesses the client service provider 18 from a given access point via the Internet connection provider 16 and the Internet to select a particular IP site of the content provider 17 from the recommended menu 415. Next, the user of the PDA 10 requests the particular content provider 17 for the subscription via the Internet connection provider 16 and the Internet (\mathring{1}). At this moment, the flash ID, which is the unique identification information of the mobile information terminal 10, is automatically read by an SSL (Secure Source Layer) compliant browser for example, the retrieved flash ID is encrypted, and the encrypted flash ID is transmitted to the client service provider 18 via the content provider 17. This processing is transparent to the user. Receiving the request from the user, the content provider 17 requests the client service provider 18 for Web channel registration (\mathring{2}). Receiving the request, the client service provider 18 references the customer DB 414 on the basis of the flash ID to perform user authentication. At the same time, the client service provider 18 checks the charging surrogate service provider 19 for the charging service registration (\mathring{3}). In response, the charging surrogate service provider 19 sends the information indicative whether the user in question has already made the registration for the charging surrogate service or not to the client service provider 18 (\mathring{4}). If the registration has already been made, the client service provider 18 requests the charging surrogate service provider 19 for the additional charging for this new content provider information providing service (\mathring{5}). If the registration has not yet been made, the client service provider 18 requests the charging surrogate service provider 19 for the user registration and, at the same time, charging. After this registration, the information indicative of the registration OK is sent to the client service provider 18 (\mathring{6}). This information may also be separately sent to the user by electronic mail or postal mail.

When the information indicative of the registration already made or the registration OK comes from the charging surrogate service provider 19, the client service provider 18 sets the site ID registered as related with the flash ID of the user in question of the customer DB 414. This becomes the so-called My Menu of the user in question. At the same time, the client service provider 18 sends the message indicative of the registration OK to the content provider 17 (\mathring{7}). Then, the content provider 17 starts distributing the requested content to the PDA 10 (\mathring{8}).

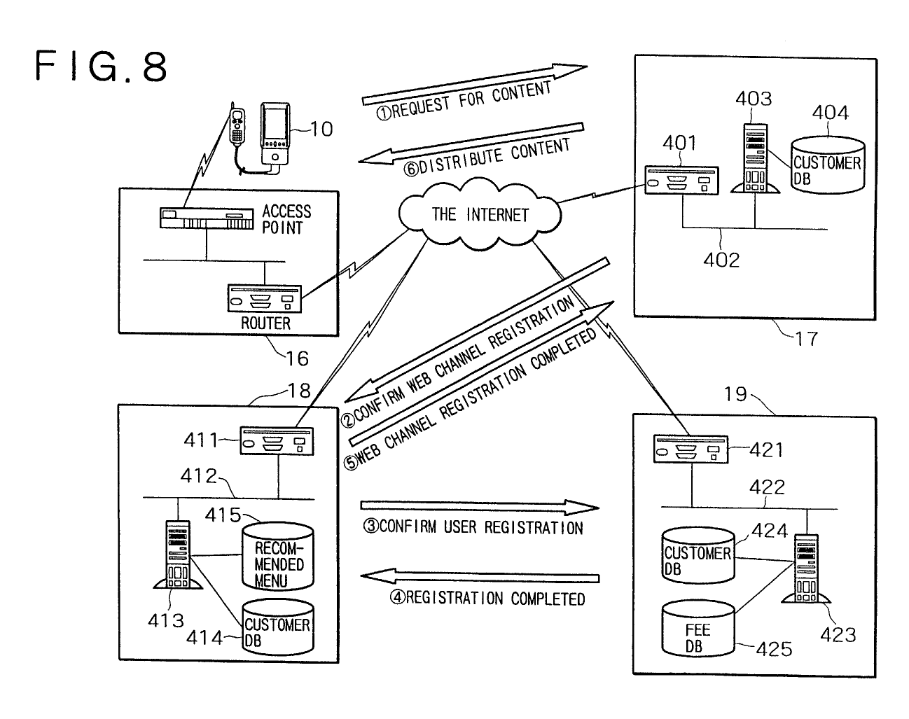

Referring to FIG. 8, there is shown a procedure corresponding to the procedure shown in FIG. 7 for the user in question to access the site from the PDA 10 after the completion of the Web channel registration described with reference to FIG. 7. When the user requests the site in question for a particular piece of content (\mathring{1}), the content provider 17 checks the client service provider 18 whether the Web channel registration has already been made or not (\mathring{2}). The client service provider 18 performs user authentication on the basis of the flash ID and checks the charging surrogate service provider 19 for the user registration for the charging service (\mathring{3}). If the user registration has been made with the charging surrogate service provider 19 (\mathring{4}), the client service provider 18 sends the information indicative of the completion of the Web channel registration to the content provider 17 (\mathring{5}). Consequently, the content provider 17 distributes the requested content to the PDA 10 (\mathring{6}) . In the course of this processing, the flash ID which is encrypted for user authentication is used. However, the encryption process is transparent to the user, so that the user may only select the site from the My Menu. Namely, the user need not enter a special user ID every time the user accesses the site. However, depending on the services to be provided after accessing the site, the user may be required to enter a password which is unique to a particular service.

The following describes an example of processing from Internet access to Web channel registration (subscription) with reference to specific PDA screens.

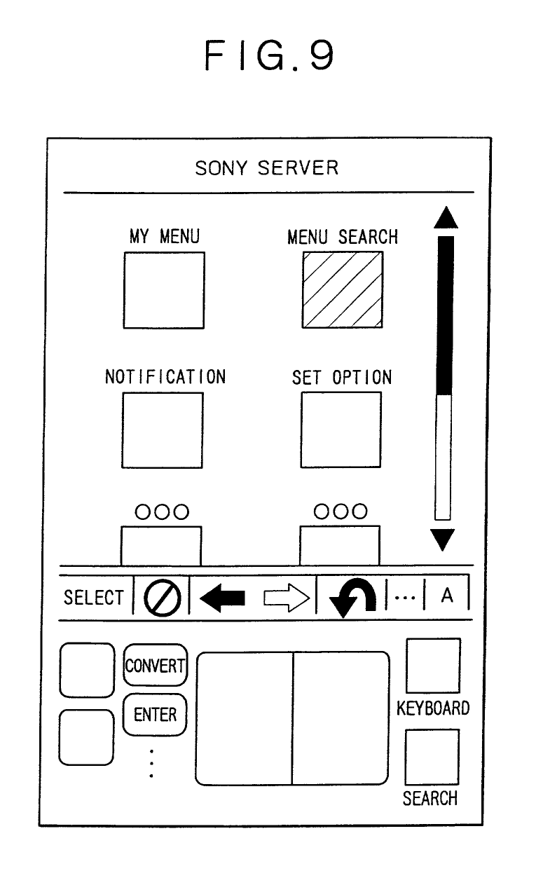

Now, assume that the PDA is connected to the mobile phone 15 and a Web browser icon (not shown) is selected and entered from a menu screen on the PDA 10. First, the PDA 10 is connected to the Internet connection provider by dial-up and the user enters the login ID and the login password, upon which the Internet connection is completed. Then, an exemplary initial menu screen supplied from the Web server of the client service provider shown in FIG. 9 is displayed. This site is set as a home page by default or is selected by the user. It should be noted that this screen is shown on the display section 21 shown in FIG. 2, the main portion of the screen being a browser display section, below which various operation icons and a hand-written character recognition input area are arranged. This input area may be displayed only when necessary.

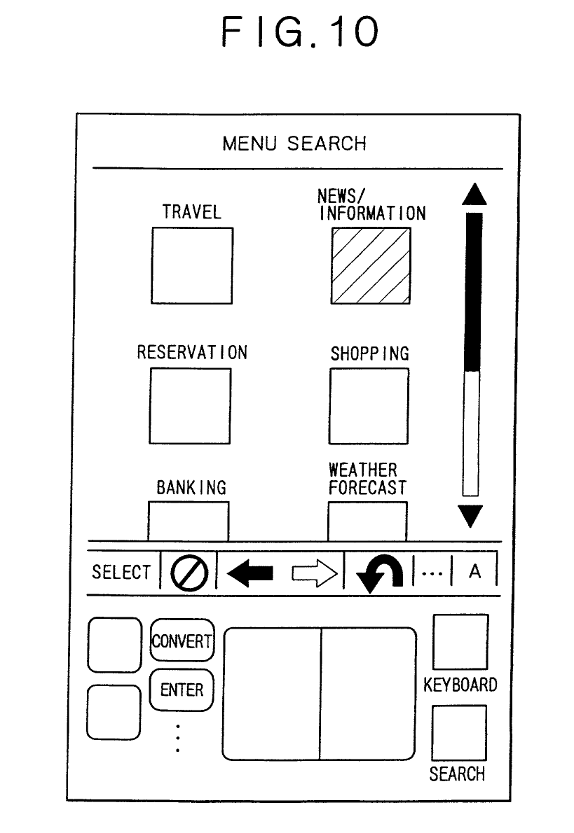

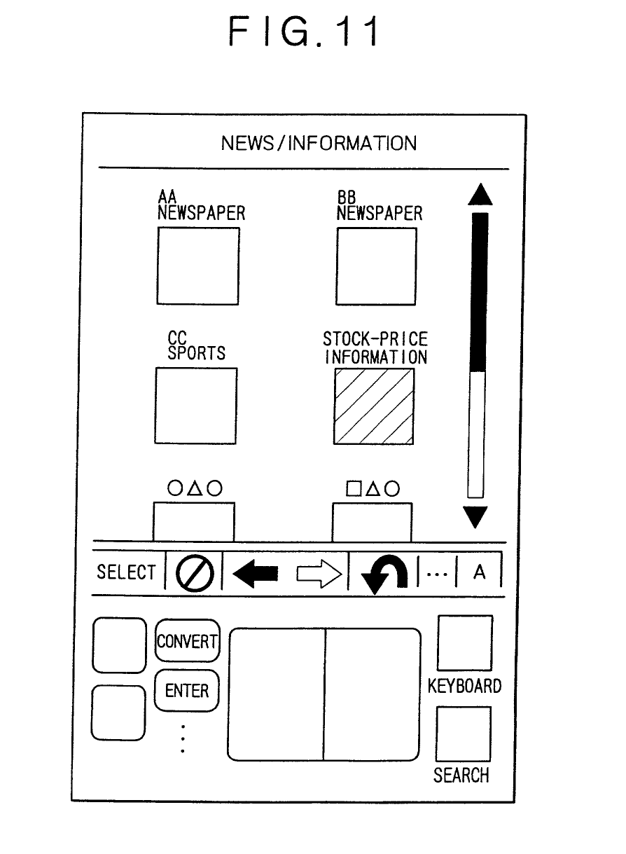

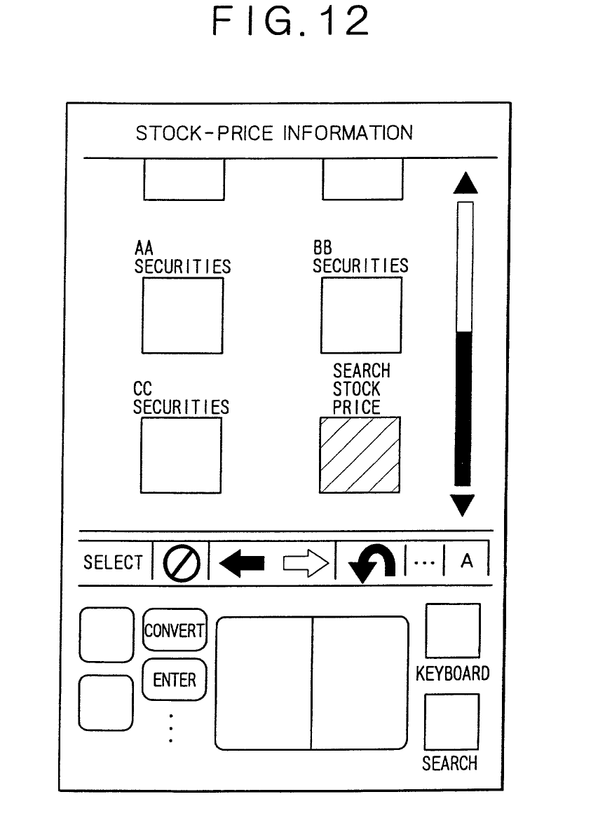

“Menu Search” in the menu screen shown in FIG. 9 corresponds to the above-mentioned recommended menu 415 (FIG. 7) which allows the link from this icon to any of the official sites registered with this client service provider. When this icon is selected and entered, icons classified by site as shown in FIG. 10 are displayed. When the user selects one of the icons (in this example, “News/Information”) from this screen and enters the selected icon, icons associated with information provision service sites belonging to the News/Information are displayed as shown in FIG. 11. Further, when the user selects one of these icons (in this example, “Stock-Price Search”), a final menu screen as shown in FIG. 12 is displayed. From this screen, the user can select the link to a desired IP site (in this example, the “Stock-price Search” site). The number of hierarchical menus depends on a method of classification used.

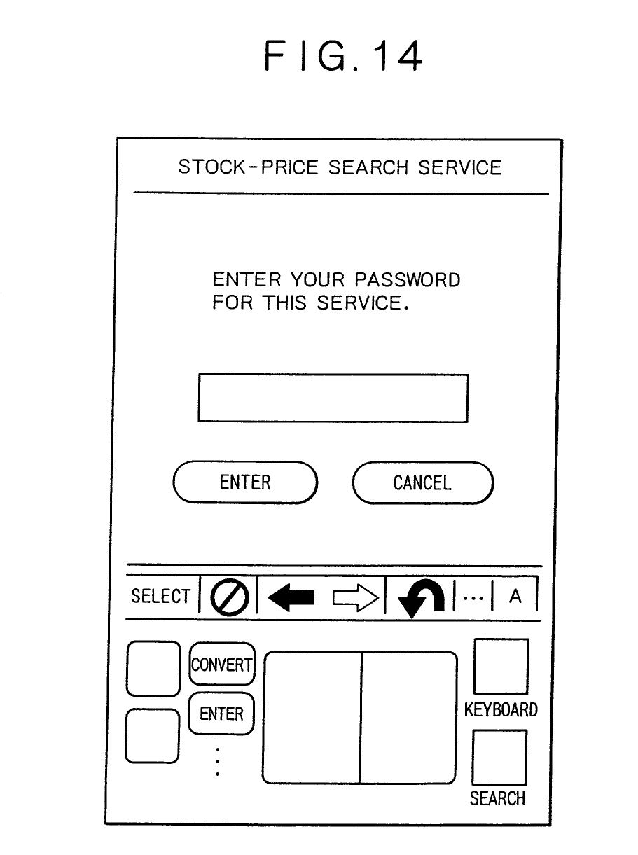

Because the stock-price search service is for pay, the user is notified that My Menu registration is necessary for the use of this service. Until the user makes My Menu registration, the procedure will not precede any further. When the user makes the registration, the user is requested to input the password for the service in the client service provider as shown in FIG. 14. Because the user identification based on the flash ID is performed transparently to the user as described before, the user is not requested to input the user ID. This password functions to prevent any unauthorized user from using this mobile information terminal.

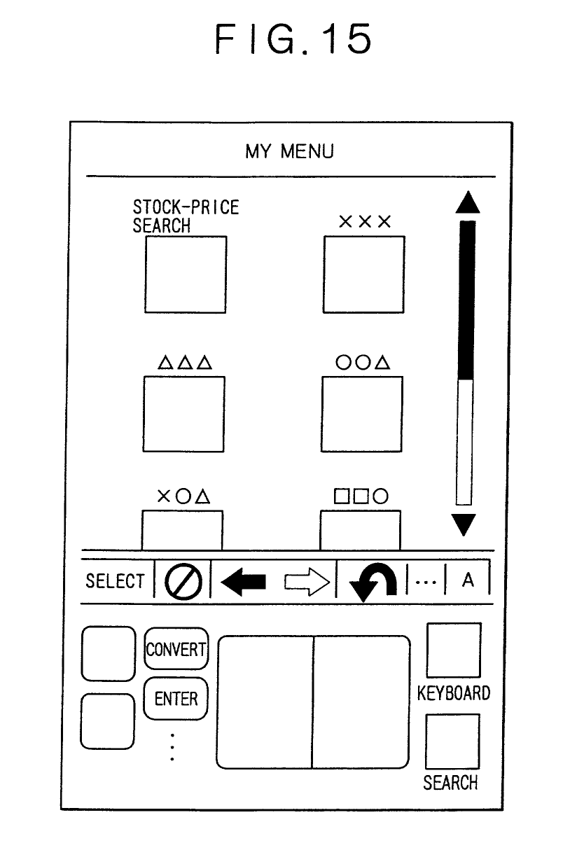

When the My Menu registration has been made, procedure goes from the “My Menu” icon in the screen shown in FIG. 9 directly to a My Menu screen shown in FIG. 15, thereby allowing the user to use the services provided by the desired IP site.

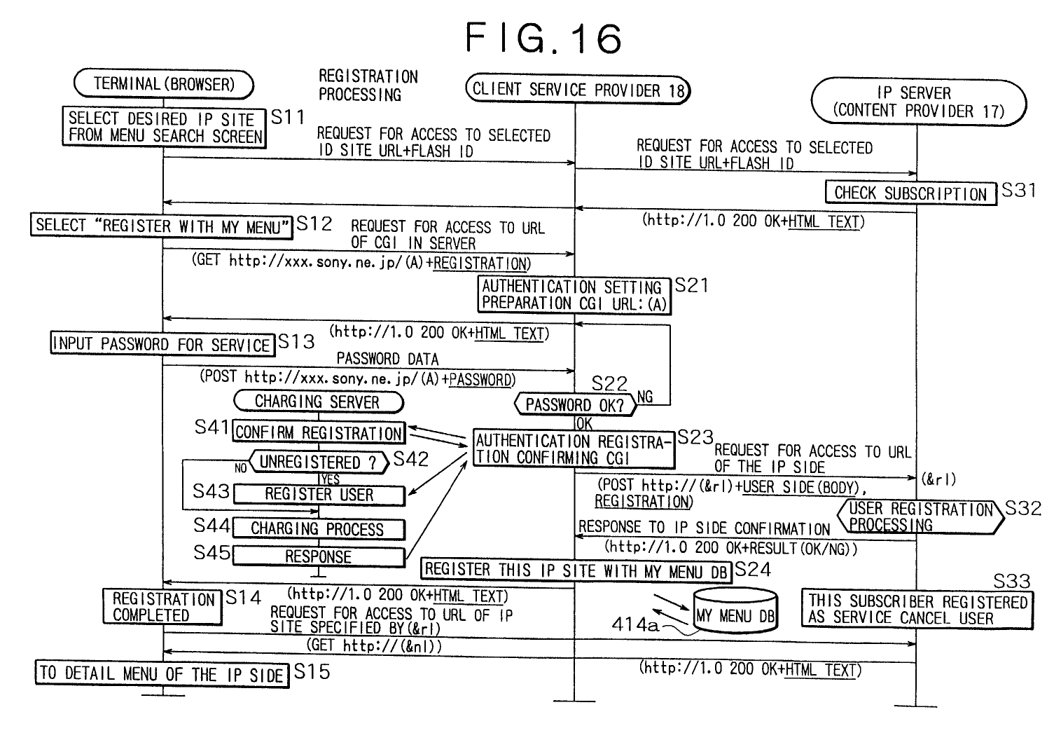

The following describes in detail the time-series operations of the client and each server in each of the stages of My Menu registration, service usage, and service cancellation with reference to FIGS. 16, 17, and 18 respectively.

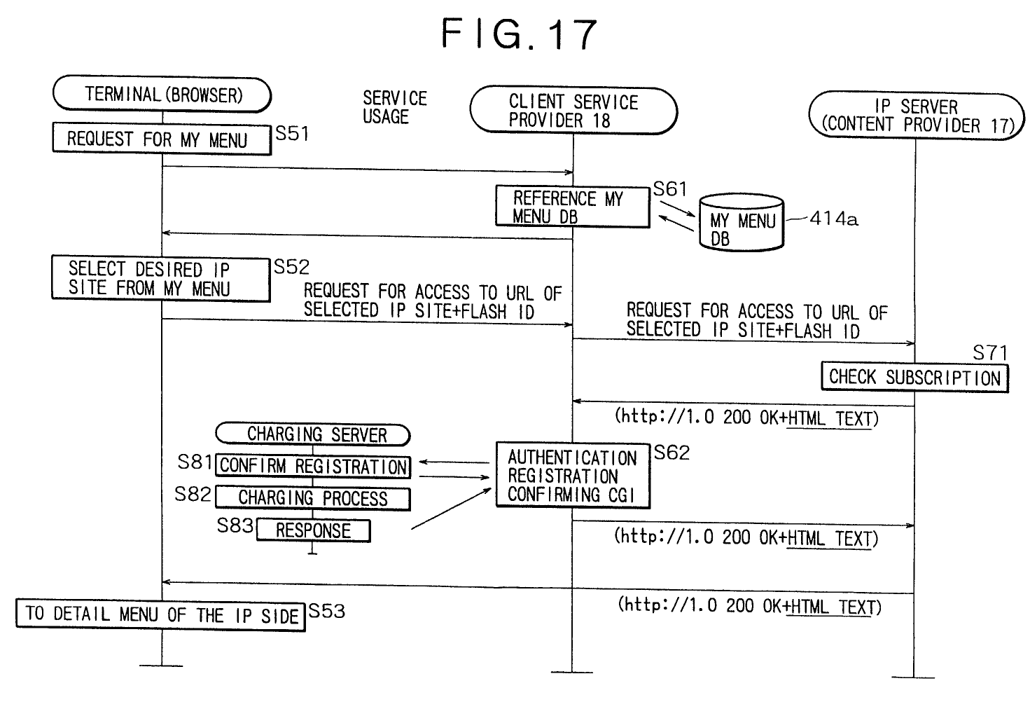

My Menu registration processing shown in FIG. 16 starts with a stage in which a desired IP site has been selected from the above-mentioned menu search screen (S11). The browser of the PDA (terminal) requests the client service provider for accessing the URL of the selected IP site and sends the encrypted flash ID thereto. The client service provider decrypts the received flash ID, encrypts it again, and transfers the encrypted flash ID to the IP server of that IP site. The IP server decrypts the received flash ID and checks whether the terminal user having this flash ID is a subscription member of this IP server (S31). If the user is a subscription member, it indicates that the subsequent My Menu registration procedure shown in FIG. 16 has already been performed. Consequently, as will be described in the service usage stage shown in FIG. 17, the user can get the distribution of the desired content without going through the My Menu registration procedure again.

If the user is not a subscription member, the IP server returns a predetermined HTML text. This HTML text includes the following parameters in the present embodiment.

IP site management number. This is the site ID of the IP server for identifying each individual IP site.

URL (A) of authentication setting preparation CGI on the client service provider side. This is information indicative of a CGI (Common Gateway Interface) address. The CGI itself is a known functional expansion facility of each Web browser. By use of the CGI, the Web browser calls an external program to request for processing and gets processing results, thereby realizing the execution of processing which the Web browser cannot execute. In this example, in the client service provider, the IP server includes, in the HTML text, the information for the CGI to be executed later.

URL (&rl) of user registration CGI on the IP site side. This information identifies the CGI to be activated later in the IP site.

URL (&nl) of the destination to which the IP site passes control upon the end of this registration processing.

Registration command (&act=reg (registration)). This information determines an anchor point for passing control to an authentication setting preparation stage by user's commanding the My Menu registration.

When the user selects “Register with My Menu” in the display screen of this HTML text, the authentication setting preparation CGI is activated in the client service provider (S21). In this authentication setting preparation, the client service provider sends the HTML text for prompting the user to input the password for a service in the client service provider to the browser. On the other hand, the browser prompts the user to input that password (S13), sending the inputted password to the client service provider. The client service provider matches the password of the user stored in the customer DB against the received password (S22). If a mismatch is found, the client service provider notifies the user thereof, prompting the user for inputting the correct password.

If a match is found, the client service provider starts the authentication registration confirming CGI (S23). This authentication registration confirmation checks whether the flash ID of this user is registered with the customer DB 414 (FIG. 5) and inquires the charging server whether this user is registered as a member of the charging surrogate service. The charging server references its own customer DB 424 (shown in FIG. 7 for example) to check if this user is registered or not and sends a result to the authentication registration confirming CGI (S41). If this user is found not registered (S42, YES), the charging server registers this user for the charging surrogate service as instructed by the authentication registration confirming CGI (S43). Further, the charging server references a fee DB 425 (FIG. 7) to check the fee for the content in question and performs predetermined charging processing (S44). The results of the registration and the charting are sent to the authentication registration confirming CGI (S45).

When the authentication registration confirmation has been completed, the client service provider requests the IP server to start a user registration processing CGI. At this moment, the personal information for user registration is also sent to the IP server. On the basis of the given information, the IP server performs the user registration for its information providing service (S32). Then, the IP server sends an acknowledgement response to the client service provider.

Receiving the acknowledgement response, the client service provider registers the site ID of this IP site in relation with the flash ID of this user (S24). A My Menu DB 414a may be the above-mentioned customer DB 414 itself or a subset taken therefrom.

Subsequently, the client service provider sends an HTML text notifying the completion of the registration to the browser of the terminal. The HTML text includes anchor point information for requesting the access to the URL of the IP site. By indicating this anchor point, the user can link to a desired IP site. Namely, the HTML text for determining desired page information is sent from the IP site to the browser.

Subsequently, the link destination is determined by the detail menu of this IP site (S15).

To receive a service from a same IP site again after disconnection from the Internet, the user selects and enters the same IP site registered with the My Menu as shown in FIG. 17, which allows the user to receive a desired service from the IP site without having to enter the user ID and the password. Namely, when the user request the My Menu at the terminal (S51), the client service provider returns the My Menu information about the user to the browser (S61). The user selects and enters a desired IP site from this My Menu. In response, the browser requests the client service provider for accessing the URL of the selected IP site and sends the encrypted flash ID to the client service provider. The client service provider decodes the received flash ID, encrypts the flash ID again, and sends it to the IP server of the IP site along with the access request. The IP server decrypts the encrypted flash ID and determines whether the terminal user having this flash ID is really a subscription member of the IP server (S71). If the user is not registered with the customer DB 404 of this site for some reason, the IP server notifies the client service provider thereof, upon which the access to the IP site is rejected. Normally, however, such a situation is not encountered, so that this process of subscription checking may be omitted.

If the user is found to be a subscription member, then the IP server returns a predetermined HTML text. This HTML text includes at least the IP site management number in the present embodiment.

In response, the client service provider executes an authentication registration confirming CGI (S62). This CGI confirms that the flash ID of the user in question is already registered with the customer DB 414 and the site ID of the IP site in question is already registered in relation with that flash ID and, at the same time, inquires the charging server whether the user is already registered as a member of the charging surrogate service. The charging server references its own customer DB 424 to check whether or not the user has been registered and the user's payment is in arrears, and the charging server sends the checking results to the authentication registration confirming CGI (S81). If there is found no problem, the charging server references the fee DB 425 to check the fee for the requested content, performing predetermined charging processing (S82). The results of the registration and charging are sent to the authentication registration confirming CGI (S83).

After the completion of the authentication registration confirmation, the client service provider notifies the IP server of the permission of the content distribution to the terminal browser. Consequently, the HTML text for determining the desired page information is sent from the IP site to the browser.

Because the service usage fee in the present embodiment is charged on a monthly basis after the My Menu registration, it is not so significant to request the IP site with which the My Menu registration has been made for the password input at the later access to the IP site, thus not requesting the password input. However, the password input may be requested if the charging is performed (other than charging for obtaining the communication fee) every time access is made to the IP site. In this case, the user ID need not be inputted, either.

In the case of the services requiring higher security such as bank balance inquiry and funds transfer for example briefly referred to above, it is possible that the user ID and password dedicated to these services be requested between the IP site and the user. The present invention does not exclude these requirements for the user.

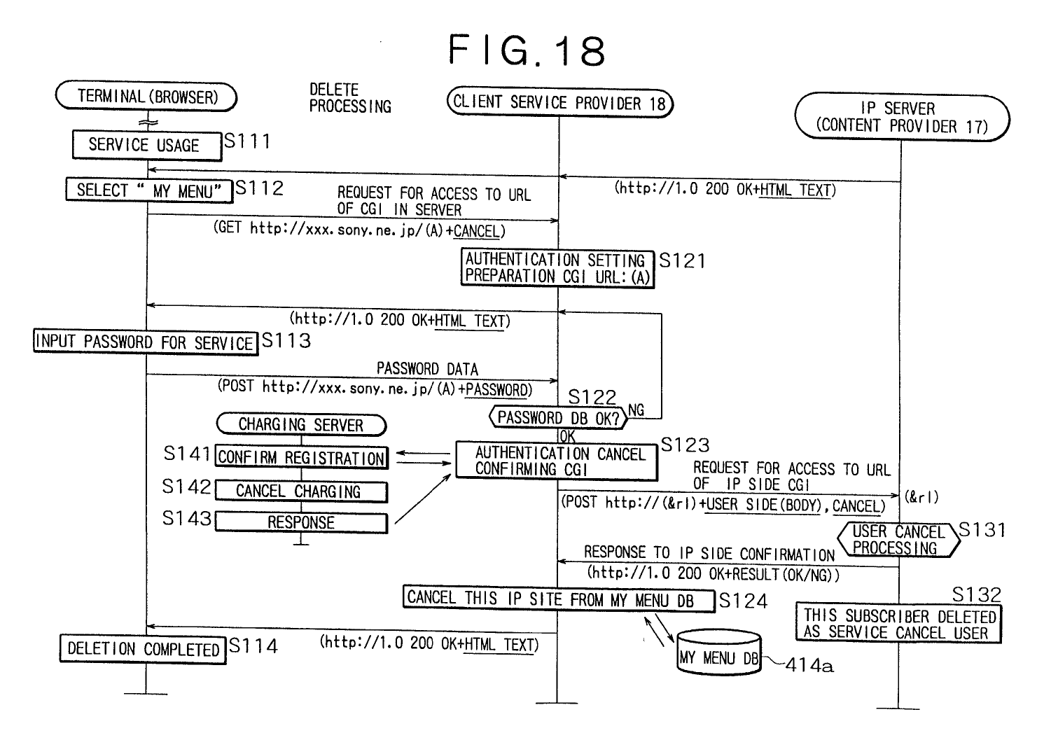

Referring to FIG. 18, there is shown a procedure for canceling the My Menu registration. When, during the use of a service of a certain registered IP site (S111), the user selects “Cancel My Menu” on a display screen based on an HTML text supplied from the IP server (S112), the browser requests the client service provider to execute the authentication setting preparation CGI for My Menu cancellation. In response, the client service provider prompts the user to input the password for the service in the client service provider. The browser in turn prompts the user to input the requested password (S113), the inputted password being sent to the client service provider. The client service provider matches the received password against the password of the user stored in the customer DB (S122). If a mismatch is found, the client service provider notifies the user thereof, prompting him to input the correct password.

If the password is found matching, the client service provider starts the authentication cancel confirming CGI (S123). This authentication cancel confirmation makes sure whether the flash ID of the user is already registered with the customer DB 414. After confirming the registration with the charging server (S141), the charging server cancels the charging starting with the next month (S142), notifying the client service provider thereof (S143).

After the completion of the authentication cancel confirmation, the client service provider requests the IP server to start a user cancel processing CGI. In response, the IP server executes the cancel processing (namely the deletion of the registration) for the user (S131). Then, the IP server sends an acknowledgement response to the client service provider.

In response, the client service provider deletes the site ID of the IP site registered in relation with the flash ID of that user from the My Menu DB 414a (S124).

Subsequently, the client service provider sends an HTML text to the terminal browser for notifying it of the completion of the deletion (S114).

The flash ID may be encrypted by use of various encryption algorithms. The present embodiment uses SSL (Secure Socket Layer), which is a typical encryption algorithm for use between a Web server and a Web browser.

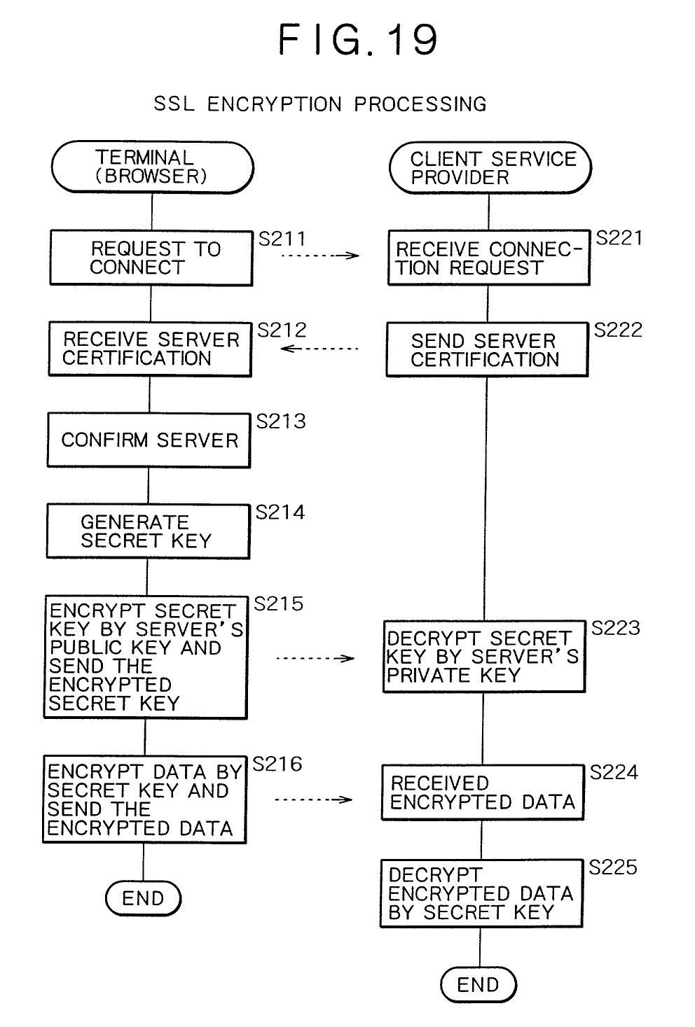

Referring to FIG. 19, there is shown the processing flows of the terminal browser and the client service provider in authenticating the client service provider by the browser and sending encrypted data from the browser to the client service provider. First, the browser sends a request for connection to the server (S211). Receiving this request (S221), the server sends its server certificate to the browser (S222). This certificate is issued by a certificate authority which manages the public key of the user (in this example, the client service provider). The server certificate contains the public key of the server, the expiration date of the certificate, the serial number allocated by the authority, the name of the authority, and a digital signature. The digital signature is generated by encrypting a hash value having contents of a certificate by the private key of the certificate authority for tamper prevention. The browser incorporates the public keys of main certificate authorities and decodes the digital signature by use of the corresponding public key to verify the identity of the server. Namely, the public key encryption system is used to verify, by the user, that a particular Web server is an appropriate one. Thus, the browser authenticates the server (S213). Then, the browser generates a secret key (based on the common key encryption system) for this session (S214), encrypts the generated secret key by the public key of the server, and sends the encrypted secret key to the server (S215). Further, by use of this secret key, the browser encrypts the data to be encrypted and sends the encrypted data to the server (S216). Upon reception of the encrypted data (S224), the server decrypts the encrypted data by the secret key (S225). Namely, for actual data transfer operations, the secret key encryption system faster in encryption and decryption processing than other encryption system is used.

The above-mentioned processing also holds with the transmission of the flash ID from the client service provider to a content provider in an encrypted manner.

In the above-mentioned first embodiment, the mobile information terminal accesses the Internet through a communication device externally connected to the mobile information terminal. If the mobile information terminal incorporates communication capabilities, such an external communication device need not be connected. The present invention is also applicable to camera-equipped digital mobile phones compliant with IMT-2000 such as W-CDMA for example. The following describes such a camera-equipped digital mobile phone practiced as a second embodiment of the invention.

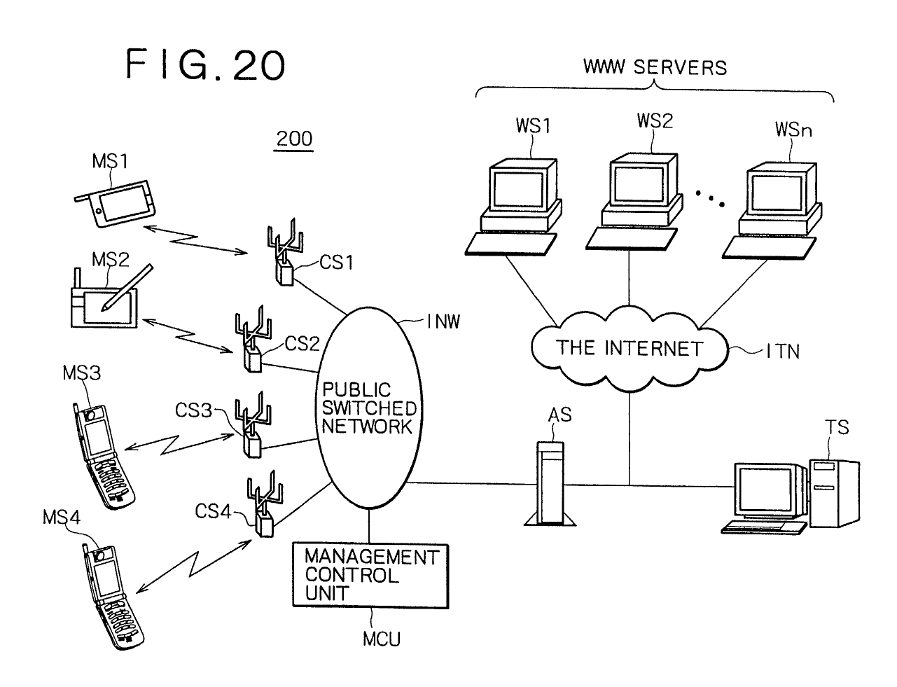

Referring to FIG. 20, there is shown an overall configuration of a networks system which uses the above-mentioned digital mobile phones. In FIG. 20, reference numeral 200 denotes the network system to which mobile phones MS3 and MS4 are connected. Base stations CS1 through CS4, stationary wireless stations, are each arranged in each of cells obtained by dividing a communication service provision area into a desired size.

The base stations CS1 through CS4 wirelessly connect the mobile information terminals MS1 and MS2 described with reference to the first embodiment and the camera-equipped digital mobile phones MS3 and MS4 by W-CDMA (Wideband Code Division Multiple Access) system for example and can communicate mass data at a maximum data transfer rate of 2 Mbps by use of 2 GHz frequency band.

Because the mobile information terminals MS1 and MS2 and the camera-equipped digital mobile phones MS3 and MS4 can communicate mass data at the high data transfer rate based on W-CDMA system, various kinds of data communication of not only audio talk but also electronic mail transfer, simplified home page browsing, and image transfer can be executed.

The base stations CS1 through CS4 are connected to a public switched network INW by wired line. The public switched network INW is connected to the Internet ITN, many subscriber wired terminal devices, computer networks, and intranets for example, not shown.

The public switched network INW is also connected to an access server AS of an Internet service provider. The access server AS is connected to a content server TS owned by the Internet service provider.

The content server TS is equivalent to the mobile content provider in the first embodiment and provides content such as simplified home pages for example as compact HTML files upon request from subscriber wired terminals, the mobile information terminals MS1 and MS2, and the camera-equipped digital mobile phones MS3 and MS4.

The Internet ITN is connected to many WWW (World Wide Web) servers WS1 through WSn. The WWW servers WS1 through WSn are accessed from the subscriber wired terminals, the mobile information terminals MS1 and MS2 and the camera-equipped digital mobile phones MS3 and MS4 in accordance with the TCP (Transmission Control Protocol)/IP (Internet Protocol) standard.

With the mobile information terminals MS1 and MS2 and the camera-equipped digital mobile phones MS3 and MS4, the communication with the base stations CS1 through CS4 is made by 2-Mbps simplified transport protocol, while the communication from the base stations CS1 through CS4 to the Internet ITN and the WWW servers WS1 through WSn is made by TCP/IP.

A management control unit MCU is connected via the public switched network INW to the subscriber wired terminals, the mobile information terminals MS1 and MS2, and the camera-equipped digital mobile phones MS3 and MS4. In the present second embodiment, this management control unit MCU plays the roles of the above-mentioned client service provider and charging surrogate service provider, thereby performing the authentication processing and charging processing on the subscriber wired terminals, the mobile information terminals MS1 and MS2, and the camera-equipped digital mobile phones MS3 and MS4.

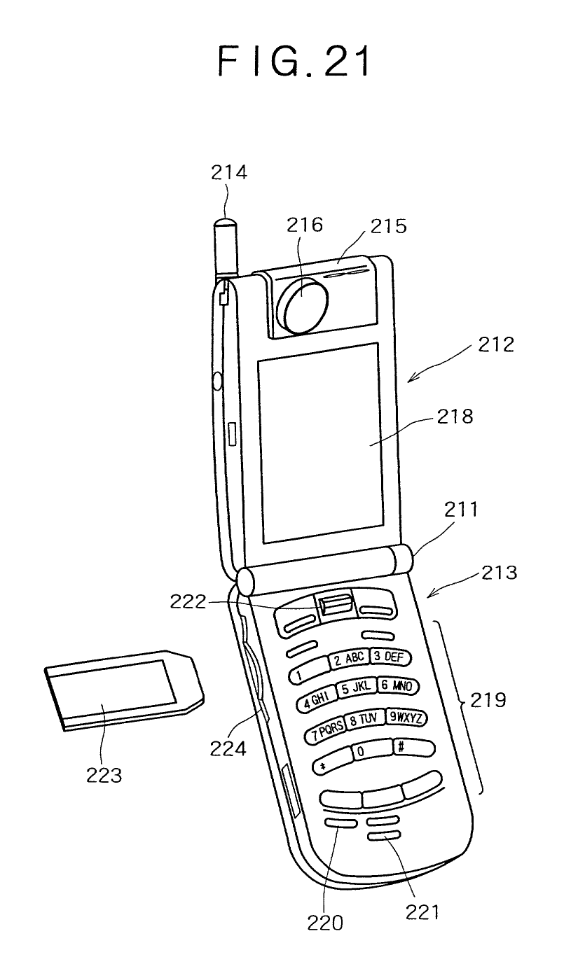

The following describes an external configuration of the camera-equipped digital mobile phone MS3 to which the present invention is applied. As shown in FIG. 21, the camera-equipped digital mobile phone MS3 is composed of a display section 212 and a main body 213 and collapsible around a hinge 211 at the center.

The display section 212 has a retractable transmission/reception antenna 214 at the upper left side. The camera-equipped digital mobile phone MS3 transmits and receives radio waves with the base station CS3 via the antenna 214.

The display section 212 has a camera section 215 which is pivotable in a range of about 180 degrees at the upper center section. The camera-equipped digital mobile phone MS3 images desired objects by a CCD camera 216 housed in the camera section 306.

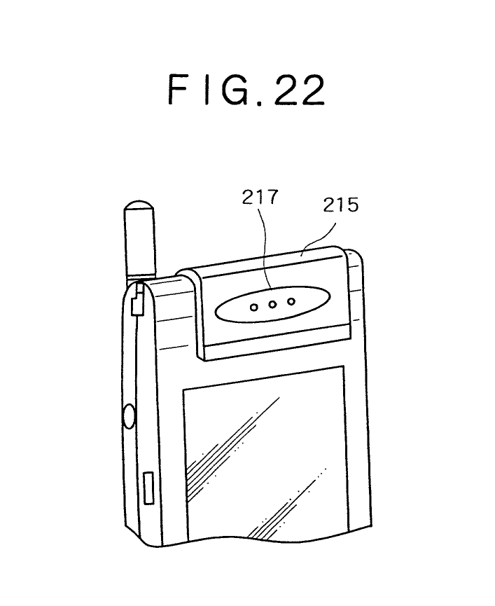

If the camera section 215 is rotated by the user about 180 degrees, the display section 212 is positioned with a speaker 217 arranged at the rear center of the camera section 215 faced to the front side as shown in FIG. 22. Thus, the camera-equipped digital mobile phone MS3 gets in the normal audio talk mode.

In addition, the display section 212 has a liquid crystal display (LCD) 218 at the front center section. The liquid crystal display 218 displays the contents of electronic mail, a simplified home page, and an image taken by the CCD camera 216 of the camera section 215 in addition to radio wave reception status, battery remaining amount, names and numbers of phones registered as a telephone directory, and an outgoing call history.

On the other hand, the main body 213 has operation keys 219 including numeric keys “0” through “9,” a call key, a redial key, a hang-up/power key, a clear key, an electronic mail key, and other keys on the front surface. Various commands are inputted from these operation keys 219 into the camera-equipped digital mobile phone MS3.

Below the operation keys 219 of the main body 213, a memo button 220 and a microphone 221 are arranged. When the memo button 220 is pressed, the camera-equipped digital mobile phone MS3 records the voice of the called party. The camera-equipped digital mobile phone MS3 picks up the voice of the user in the talk mode through the microphone 221.

In addition, a rotatable jog dial 222 is arranged over the operation keys 219 on the main body 213 in a manner in which the job dial 222 is slightly projecting from the surface of the main body 213. In accordance with the rotary operation of the jog dial 222, the camera-equipped digital mobile phone MS3 executes the scrolling of a telephone directory list or an electronic mail displayed on the liquid crystal display 218, the turning of the displayed pages of simplified home page, and the feeding of displayed images, for example. For example, the main body 213 selects a desired telephone number from among those in a telephone directory list displayed on the liquid crystal display 218 by the rotation of the jog dial 222 by the user and, when the jog dial 222 is pressed into the main body 213, enters the selected telephone number, thereby automatically originating a call to the party at the selected telephone number.

It should be noted that a battery pack, not shown, is loaded in the main body 213 at the rear side. When the hang-up/power key is turned on, power is supplied from the battery pack to each circuit, making the camera-equipped digital mobile phone MS3 ready for operation.

The main body 213 also has a Memory Stick slot 224 at the upper left side in which the detachable Memory Stick 223 is loaded. When the memo button 220 is pressed, the camera-equipped digital mobile phone MS3 records the voice of the called party into the loaded Memory Stick 223. In accordance with the operation of the user, the camera-equipped digital mobile phone MS3 records an electronic mail, a simplified home page, or an image taken by the CCD camera 216 into the loaded Memory Stick 223.

The Memory Stick 223 is a kind of flash memory card developed by Sony Corporation, the applicant hereof. The Memory Stick 223 incorporates a flash memory element, one kind of EEPROM (Electrically Erasable and Programmable Read Only Memory) which is a nonvolatile memory capable of electrically rewriting and deleting, housed in a plastic case, in a small and thin shape, having dimensions of 21.5 mm×50 mm×2.8 mm. The Memory Stick allows writing and reading of various data such as images, voices, and music via a 10-pin terminal.

The Memory Stick 223 uses a proprietary serial protocol which guarantees compatibility with the devices wherein it is used even if the specifications of the incorporated flash memory have been changed due to the increase in its capacity for example, realizes the high-speed performance of maximum write rate of 1.5 MB/S and maximum read rate of 2.45 MB/S, and ensures the high reliability by the provision of an erroneous-deletion preventing switch.

Consequently, the camera-equipped digital mobile phone MS3, configured to detachably load the Memory Stick 223, can share data with other electronic devices via the Memory Stick 223.

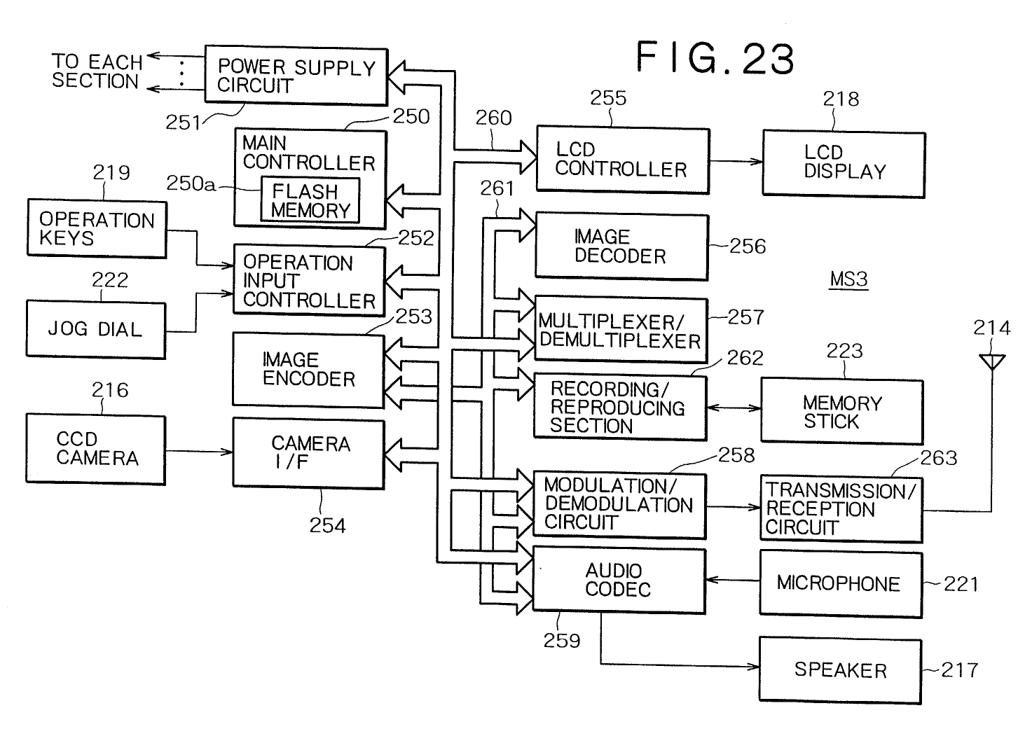

The following describes an exemplary circuit configuration of the camera-equipped digital mobile phone MS3. As shown in FIG. 23, the camera-equipped digital mobile phone MS3 is configured so that a main controller 250 for centrally controlling each portions of the display section 212 and the main body 213 is connected to a power supply circuit 251, an operation input controller 252, an image encoder 253, a camera interface 254, an LCD (Liquid Crystal Display) controller 255, an image decoder 256, a multiplexer/demultiplexer 257, a recording/reproducing section 262, a modulation/demodulation circuit 258, and an audio codec 259 via a main bus 260, and the image encoder 256, the image decoder 256, the multiplexer/demultiplexer 257, the modulation/demodulation circuit 258, and the audio codec 259 are interconnected by a synchronous bus 261.

The power supply circuit 251, when the hang-up/power key is turned on by the user, supplies power from the battery pack to each component circuit, thereby making the camera-equipped digital mobile phone MS3 ready for operation.

Under the control of the main controller 250 composed of a CPU, a ROM, and a RAM for example, the camera-equipped digital mobile phone MS3 converts an audio signal picked up by the microphone 221 in the audio talk mode into digital audio data through the audio codec 259. The camera-equipped digital mobile phone MS3 performs spread spectrum processing on the digital audio data through a modulation/demodulation circuit 258 and performs digital-to-analog conversion and then frequency conversion on the digital audio data through a transmission/reception circuit 263, sending the resultant data via the antenna 214.

The camera-equipped digital mobile phone MS3 amplifies a reception signal received at the antenna 214 in the audio talk mode, performs frequency conversion and analog-to-digital conversion on the amplified signal, performs reverse spread spectrum processing on the converted signal, and converts the resultant signal into an analog audio signal through the audio codec 259. The camera-equipped digital mobile phone MS3 outputs a sound corresponding to this analog audio signal from the speaker 217.

Further, in the data communication mode, when sending electronic mail, the camera-equipped digital mobile phone MS3 sends the text data of electronic mail inputted from the operation keys 219 and the jog dial 222 to the main controller 250 via the operation input controller 252.

The main controller 250 performs spread spectrum processing on the text data through the modulation/demodulation circuit 258 and then digital-to-analog conversion and frequency conversion through the transmission/reception circuit 263, sending the resultant text data to the base station CS3 (FIG. 20) via the antenna 214.

In the data communication mode, when receiving an electronic mail, the camera-equipped digital mobile phone MS3 performs, through the modulation/demodulation circuit 258, reverse spread spectrum processing on the reception signal received from the base station CS3 via the antenna 214 to restore the original data and displays the original data on the liquid crystal display 218 through the LCD controller 255 as an electronic mail.

Then, the camera-equipped digital mobile phone MS3 also can record the received electronic mail in accordance with the operation by the user into the Memory Stick 223 via the recording/reproducing section 262.

In the data communication mode, when sending image data, the camera-equipped digital mobile phone MS3 supplies the image data taken by the CCD camera 216 to the image encoder 253 via the camera interface 254.

When not sending image data, the camera-equipped digital mobile phone MS3 can also display the image data taken by the CCD camera 216 onto the liquid crystal display 218 via the camera interface 254 and the LCD controller 255.

The image encoder 253 converts the image data supplied from the CCD camera 216 into coded image data by coding and compressing based on a predetermined coding algorithm such as MPEG2 (Moving Picture Experts Group 2) or MPEG4 for example and sends the coded image data to the multiplexer/demultiplexer 257.

At this moment, the camera-equipped digital mobile phone MS3 sends an audio signal picked up by the microphone 221 while taking the image by the CCD camera 216 to the multiplexer/demultiplexer 257 via the audio codec 259 as audio data.

The multiplexer/demultiplexer 257 multiplexes the coded image data supplied from the image encoder 253 with the audio data supplied from the audio codec 259 by a predetermined algorithm, performs spread spectrum processing on the resultant multiplexed data through the modulation/demodulation circuit 258, and performs digital-to-analog conversion and frequency conversion through the transmission/reception circuit 263, outputting the resultant data via the antenna 214.

In the data communication mode, when receiving the data of a moving image file linked with a simplified home page for example, the camera-equipped digital mobile phone MS3 performs reverse spread spectrum processing on the reception signal received from the corresponding base station CS3 via the antenna 214 through the modulation/demodulation circuit 258 and sends the resultant multiplexed data to the multiplexer/demultiplexer 257.

The multiplexer/demultiplexer 257 divides the multiplexed data into coded image data and audio data, supplying the coded image data to the image decoder 256 and the audio data to the audio codec 259 via the synchronous bus 261.

The image decoder 256 generates reproduced moving image data by decoding the coded image data by the corresponding predetermined decoding algorithm such as MPEG2 or MPEG4 for example and supplies the reproduced moving image data to the liquid crystal display 218 via the LCD controller 255. Consequently, the camera-equipped digital mobile phone MS3 displays the moving image data contained in a moving image file linked with a simplified home page for example.

At the same time, the audio codec 259 converts the audio data into an analog audio signal and supplies it to the speaker 217. Consequently, the camera-equipped digital mobile phone MS3 reproduces the audio data contained in the moving image file linked with the simplified home page for example.

In this case, as with an electronic mail, the camera-equipped digital mobile phone MS3 also can record the data linked with the received simplified home page into the Memory Stick 223 via the recording/reproducing section 262 as operated by the user.

In addition to the above-mentioned configuration, the camera-equipped digital mobile phone MS3, as with the first embodiment, stores the flash ID, which is unique identification information, and a corresponding SSL-compliant browser program in a flash memory 250a in the main controller 250. On this basis of this browser program, substantially the same processing as that described with reference to the procedures shown in FIGS. 16 through 19 in the first embodiment can be executed.

A program storage medium for storing the programs that execute the above-mentioned series of processing operations which are installed initially or after sales in the mobile information terminal and the camera-equipped digital mobile phone MS3 to be ready for operation thereon includes not only a package medium such as a floppy disc, CD-ROM (Compact Disc Read Only Memory), and DVD (Digital Versatile Disc) for example but also a semiconductor memory or a magnetic disc on which these programs are stored temporarily or permanently.

Storage means for programs in these storage media is executed by use of wired or wireless communication media such as a local area network, the Internet, or digital satellite broadcasting via the various communication interfaces such as a router and modem as required.

In the above-mentioned first and second embodiments, the information processing device associated with the present invention is embodied in a mobile information terminal and a camera-equipped digital mobile phone. Obviously, the present invention is applicable to various other information processing devices such as the mobile information terminals MS1 and MS2 for example.

While the preferred embodiments of the present invention have been described using specific terms, such description is for illustrative purposes only, and it is to be understood that changes and variations may be made without departing from the spirit or scope of the appended claims. For example, the mobile information terminal in the present invention is not necessarily limited to a PDA. The present invention is also applicable to mobile personal computers, mail terminal devices, and game machines for example. The hardware configurations, screen images, and processing flows illustrated in the drawings appended hereto are for an illustrative purpose only and therefore the present invention is not limited to their details.

As described and according to the invention, the identification information unique to each mobile information terminal is used for user authentication, so that there is no limitation as with the case where telephone subscriber numbers are used. The unique identification information is encrypted for security, so that user authentication on the Internet can be realized in an information providing system independent of Internet connection service providers. User authentication is executed in a client service provider and site access information is registered for each user with a customer database in advance, so that each user need not enter his password for the second and subsequent accesses to a same site, thereby mitigating the user load imposed every time the user receives a chargeable service. This in turn lowers the barriers to the usage of chargeable services, which is also significantly advantageous for the service providers.

What is claimed is:

1. A user authentication method for an authentication server which executes user authentication between a mobile information terminal and a content providing server interconnected by an open network not guaranteeing the security of data to be transferred, comprising the steps of:
registering unique identification information stored in said mobile information terminal with a customer database of said authentication server in advance;
decoding the unique identification information encrypted by a predetermined encryption algorithm and supplied from said mobile information terminal via said open network;
determining whether the unique identification information decoded in the decoding step is registered with said customer database; and
sending a notification to said content providing server that starting of service provision for said mobile information terminal be permitted, if the unique identification information is found registered with said customer database in the determining step.

2. The user authentication method according to claim 1, further comprising the step of:
presenting, to said mobile information terminal, a recommended menu including site access information for accessing a plurality of predetermined content providing servers;
wherein a process in which site access information selected by a user of said mobile information terminal from said recommended menu displayed on said mobile information terminal is registered with said customer database in relation with the unique identification information of said mobile information terminal is included in the registering step.

3. The user authentication method according to claim 2, wherein, in the registering step, when registering said site access information with said customer database, user authentication is performed on the basis of said unique identification information before this registration and said mobile information terminal is requested to make display for prompting said user to enter a password of the user, while, if, subsequent to the registration with said customer database, an access request is made on the basis of the site access information already registered with said customer database, the user authentication on the basis of said unique identification information is performed but the request for the display for prompting the user to enter the user's password is omitted.

4. The user authentication method according to claim 3, wherein, in the registering step, a charging server is instructed to charge said user for the use of a service provided by said content providing server associated with said site access information at the time of registering said site access information with said customer database.

5. The user authentication method according to claim 4, wherein, in the registering step, a confirmation step for confirming, before instructing said charging server for the charging, that said user is a registered user of said charging server is included.

6. The user authentication method according to claim 1, wherein said open network is the Internet, through which the unique identification information is transmitted as encrypted by the predetermined encryption algorithm by a Web browser installed on said mobile information terminal.

7. The user authentication method according to claim 6, wherein unique identification information is read, by said Web browser, from a flash memory installed on said mobile information terminal and the retrieved unique identification information is transmitted as encrypted by the predetermined encryption algorithm by said Web browser.

8. The user authentication method according to claim 7, wherein said predetermined encryption algorithm is SSL (Secure Socket Layer).

9. A user authentication server which executes user authentication between a mobile information terminal and a content providing server interconnected by an open network not guaranteeing the security of data to be transferred, comprising:
registering means for registering unique identification information stored in said mobile information terminal with a customer database of said authentication server in advance;
decoding means for decoding the unique identification information encrypted by a predetermined encryption algorithm and supplied from said mobile information terminal via said open network;
determining means for determining whether the unique identification information decoded by the decoding means is registered with said customer database; and
service permission notice sending means for sending a notification to said content providing server that starting of service provision for said mobile information terminal be permitted, if the unique identification information is found registered with said customer database by the determining means.

10. The user authentication server according to claim 9, wherein said open network is the Internet, through which the unique identification information is transmitted as encrypted by the predetermined encryption algorithm by a Web browser installed on said mobile information terminal.

11. The user authentication server according to claim 10, wherein unique identification information is read, by said Web browser, from a flash memory installed on said mobile information terminal and the retrieved unique identification information is transmitted as encrypted by the predetermined encryption algorithm by said Web browser.

12. The user authentication server according to claim 11, wherein said predetermined encryption algorithm is SSL.
